(19) United States
(12) Patent Application Publication
(10) Pub. No.: US 2006/0089992 A1
(43) Pub. Date: Apr. 27, 2006

(54) Remote computing systems and methods for supporting multiple sessions

(76) Inventor: Bruce Eric Blaho, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/989,746

(22) Filed: Nov. 16, 2004

Related U.S. Application Data
(60) Provisional application No. 60/622,130, filed on Oct. 26, 2004.

(51) Int. Cl. G06F 15/16

(52) U.S. Cl. 709/227

(57) ABSTRACT

A plurality of remote computing sessions is established on a computer. Each of the plurality of remote computing sessions has an associated client device. For each of the plurality of remote computing sessions, a virtual machine for the respective remote computing session is instantiated on the computer and software is executed on the virtual machine for the respective remote computing session. There is a display image for the respective remote computing session that comprises raster data. For each of the plurality of remote computing sessions, at least a portion of the raster data of the display image for the respective remote computing session is transmitted to the client device associated with the respective remote computing session. The client device associated with the respective remote computing session displays at least a portion of the raster data.

### CROSS REFERENCE TO RELATED APPLICATION

This application is related to and claims the benefit under 35 USC 119(e) of Provisional Application Ser. No. 60/622,130 (the '130 Application), filed on Oct. 26, 2004. The '130 Application is incorporated by reference.

### TECHNICAL FIELD

The following description relates to computers in general and to remote computing in particular.

### BACKGROUND

One approach to providing computing services to multiple users involves providing each user with a separate computer on which software used by that user is executed. Such a computer is also referred to as a “personal computer” or a “workstation” and is typically located near the user. Also, each personal computer includes sufficient computing resources to execute the software used by the user of that personal computer.

Another approach to providing computing services to multiple users is to execute the software used by each user on a remote computer (also referred to as a “server” or “host”). This approach is also referred to here as “remote computing.” Each user uses a local computer (or other client device) to access the software executing on the server. The local computer and the server typically communicate with one another over a network (for example, a local area network, a wide area network, or a virtual private network (VPN)).

The local computer typically receives input from the user (for example, via a keyboard or pointing device coupled to the local computer) and communicates the received input to the software executing on the server. The software executing on the server typically generates display information that is communicated from the server to the local computer. The local computer uses the display information to render a user interface and content (collectively referred to here as the “display image”) for the software executing on the server. The local computer displays the display image on a display device (for example, a computer monitor) coupled to the local computer.

The display information generated by the software executing on the server typically comprises messages, commands, models, or objects. The local computer processes these messages, commands, models, or objects in order to render the display image for the software executing on the server. In some situations, the amount of display information that is communicated from the server to the local computer and/or the processing of the display information by the local computer to render the display image is substantial.

### SUMMARY

In one embodiment, a method comprises establishing a plurality of remote computing sessions on a computer. Each of the plurality of remote computing sessions has an associated client device. The method further comprises, for each of the plurality of remote computing sessions, instantiating, on the computer, a virtual machine for the respective remote computing session and executing software on the virtual machine for the respective remote computing session. There is a display image for the respective remote computing session that comprises raster data. The method further comprises, for each of the plurality of remote computing sessions, transmitting, to the client device associated with the respective remote computing session, at least a portion of the raster data of the display image for the respective remote computing session. The client device associated with the respective remote computing session displays the at least a portion of the raster data.

In another embodiment, a method comprises receiving from each of a plurality of client devices a request to establish a session. The method further comprises, for each request that is received, selecting at least one of a plurality of computers on which to establish the session for the respective request and instantiating a virtual machine on the computer selected for the respective request. The method further comprises, for each request that is received, establishing the session for the respective request on the virtual machine. There is a session display image for the session established for the respective request. The method further comprises, for each request that is received, transmitting, to the client device from which that request was received, at least a portion of the raster data of the session display image for the session established for the respective request.

In another embodiment, a system comprising a plurality of server computers in communication with a plurality of client devices and an access manager in communication with the plurality of server computers and the plurality of client devices. The access manager receives from each of the plurality of client devices a request to establish a session for the respective client device. For each request that is received by the access manager, the access manager selects at least one of the plurality of server computers on which to establish the session for the respective request and a virtual machine is instantiated on the server computer selected for the respective request. For each request that is received by the access manager, the session for the respective request is established on the respective virtual machine, there is a session display image for the session established for the respective request where the session display image comprises raster data, and at least a portion of the raster data of the session display image for the session established for the respective request is transmitted to the client device from which the respective request was received.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of a remote computing system.

FIG. 2 is a block diagram of one embodiment of a client device suitable for use in the embodiment of the system shown in FIG. 1.

FIG. 3 is a block diagram of one embodiment of a multiple-user workstation computer suitable for use in the embodiment of the system shown in FIG. 1.

FIG. 4 is a block diagram of another embodiment of a multiple-user workstation computer suitable for use in the system shown in FIG. 1.

FIG. 5 is a block diagram of another embodiment of a multiple-user workstation computer suitable for use in the system shown in FIG. 1.

FIG. 6 is a block diagram of another embodiment of a multiple-user workstation computer suitable for use in the system shown in FIG. 1.

FIG. 7 is a flow diagram of one embodiment of a method of selecting a multiple-user workstation computer on which to establish a remote computing session.

FIG. 8 is a flow diagram of one embodiment of a method of establishing a remote computing session on a multiple-user workstation.

FIG. 9 is a flow diagram of one embodiment of a method of terminating a remote computing session on a multiple-user workstation.

FIG. 10 is a flow diagram of one embodiment of a method of compressing and transmitting raster data from a session display image.

FIG. 11 is a flow diagram of one embodiment of a method of refreshing raster data displayed on a client device for a remote computing session.

Like reference numbers and designations in the various drawings indicate like elements.

### DETAILED DESCRIPTION

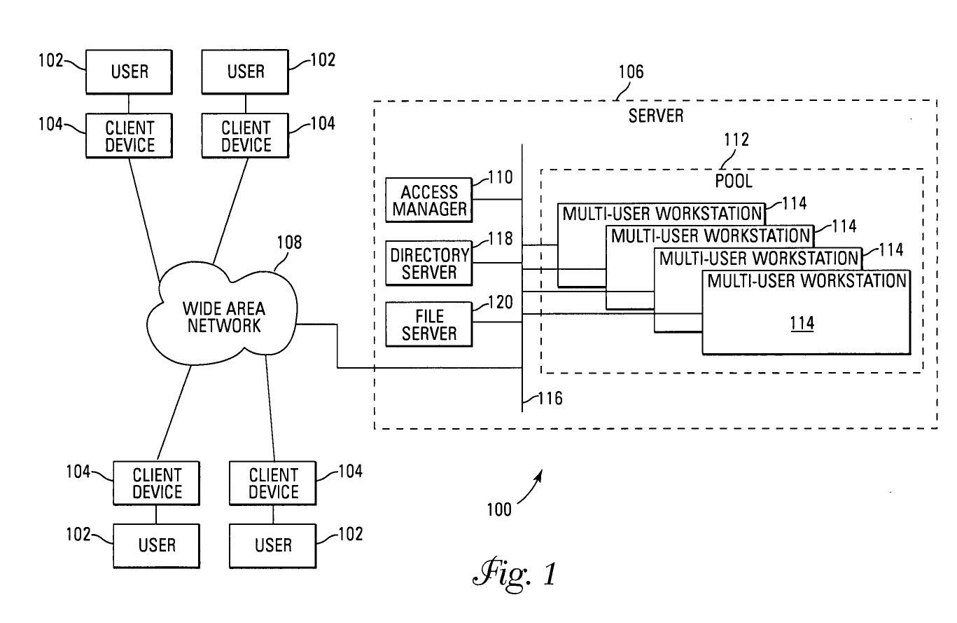

FIG. 1 is a block diagram of one embodiment of a remote computing system 100. Each of multiple users 102 uses a client device 104 to access a server 106 via a network 108. In the embodiment shown in FIG. 1, the network 108 comprises a wide area network (WAN) such as the Internet. In other embodiments, the network 108 comprises other types of networks such as a local area network (LAN) and/or a virtual private network.

The server 106 includes an access manager 110 and a pool 112 of multiple-user workstation computers 114 (also referred to here as “multiple-user workstations” 114). The access manager 110 is communicatively coupled to each of the multiple-user workstations 114 in the pool 112. In the embodiment shown in FIG. 1, a LAN 116 communicatively couples the access manager 110 to each of the multiple-user workstations 114. In other embodiments, the access manager 110 is communicatively coupled to the multiple-user workstations 114 in other ways (for example, using point-to-point links and/or a wide area network such as the Internet).

Each user 102 accesses the server 106 in order to establish a “session” in which the user 102 “uses” software that is executed on at least one multiple-user workstation 114. In the embodiment shown in FIG. 1, the server 106 also includes a directory server 118 that stores information related to the users 102 and/or the software that the user executes. In such an embodiment, the access manager 110 accesses the information stored in the directory server 118 over the LAN 116 in order to authenticate the users 102, select multiple-user workstations 114, and/or set up sessions for users 102. In one implementation, the access manager 110 is implemented in software and the directory server 118 is implemented using the lightweight directory access protocol (LDAP) in which profiles for the users 102 and the multiple-user workstations 114 are stored. Although the access manager 110 and the directory server 118 are shown as separate entities in FIG. 1, the software that implements the access manager 110 and the directory server 118, in one implementation, execute on the same computer.

The software executed by a multiple-user workstation computer 114 during a session is stored on a file server 120. In one implementation, the file server 120 comprises one or more storage devices (for example, hard disks) that are coupled to the LAN 116. Each multiple-user workstation computer 114 retrieves software stored on the file server over the LAN 116.

During a session, input supplied by the user 102 to the client device 104 is sent by the client device 104 to the selected multiple-user workstation computer 114 over the WAN 108. The selected multiple-user workstation computer 114 (and the software executing on the selected multiple-user workstation computer 114 as a part of the session) generate raster data for a display image corresponding to that user's session. The display image generated by the selected server computer 114 for the user's session is also referred to here as the “session display image.” The raster data for the session display image is compressed and sent from the multiple-user workstation computer 114 to the client device 104. The client device 104 decompresses the received raster data and uses the uncompressed raster data to display at least a portion of the session display image on a display device included in or coupled to the client device 104. The at least a portion of the session display image displayed by the client device 104 is also referred to here as the “client display image.”

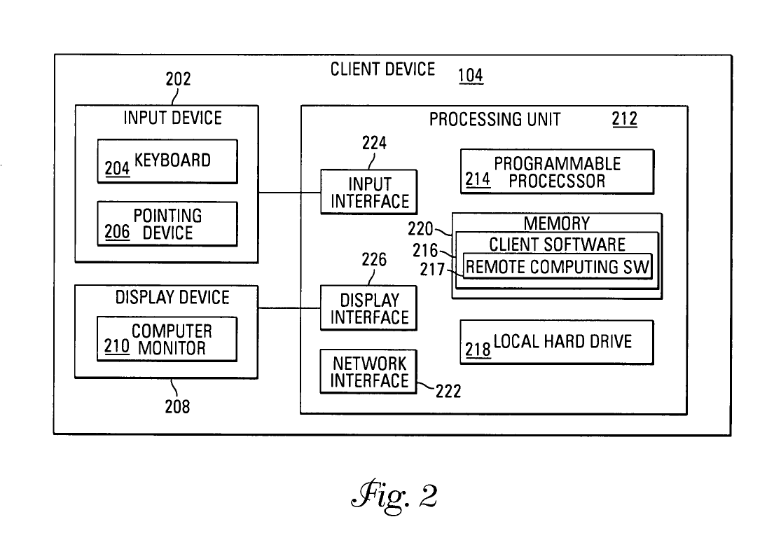

FIG. 2 is a block diagram of one embodiment of a client device 104 suitable for use in the embodiment of system I 00 shown in FIG. 1. The client device 104 includes at least one input device 202 for receiving input from the user 102 of the client device 104. In the embodiment shown in FIG. 1, the input device 202 includes a keyboard 204 and a pointing device 206 such as a mouse or trackball. Each client device 104 also includes at least one display device 208. In the embodiment shown in FIG. 2, the display device 208 comprises a computer monitor 210 such as a cathode ray tube (CRT) monitor or a liquid crystal display (LCD) monitor. When the user 102 uses the client device 104 to establish a session on the server 106, the user 102 supplies input to that session using, for example, the keyboard 204 and pointing device 206. Also, a client display image for that session is displayed on the computer monitor 210 of the client device 104 as described below.

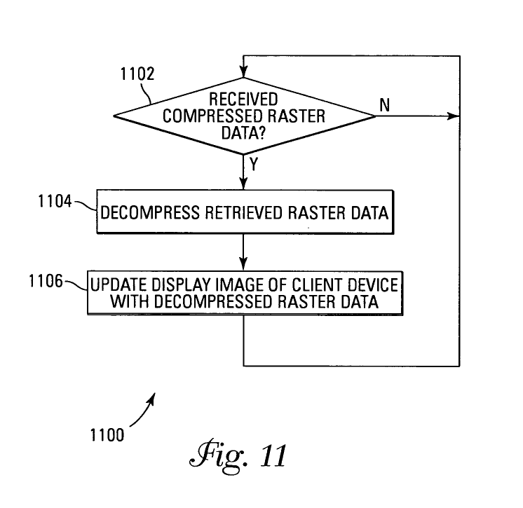

The client device 104 also includes a processing unit 212 that performs at least some of the processing described here as being performed by the client device 104. In the embodiment shown in FIG. 2, the processing unit 212 includes at least one programmable processor 214. Client software 216 (comprising appropriate program instructions) is executed by the programmable processor 214 to carry out at least some of the processing described here as being performed by the client device 104. In the embodiment shown in FIG. 2, the client software 216 includes remote computing software 217 that enables the user 102 of the client device 104 to establish and interact with a session on the server 106 of FIG. 1. For example, in one implementation of such an embodiment, the remote computing software 217 performs the processing described below in connection with the embodiment of method 1100 shown in FIG. 11. The client software 216 is stored on or in a computer-readable medium. In the embodiment shown in FIG. 2, the computer-readable medium comprises a local hard drive 218 included in the processing unit 212. During operation, the programmable processor 214 reads the program instructions that comprise the client software 216 from the hard disk 218 and executes the program instructions. The processing unit 212 further includes memory 220 for storing the program instructions and/or related data structures during execution of the client software 216. In one implementation of such an embodiment, the memory 220 includes appropriate memory such as, for example, random access memory (RAM), read only memory (ROM), and/or processor registers.

In other embodiments, the client software 216 is stored on different types of computer-readable media such as a flash disk, ROM, or removable media such as a floppy drive or a CD-ROM. In other embodiments, the computer-readable media is not local to the client device 104. For example in one such embodiment, the client software 216 is stored on a file server that is coupled to the client device 104 over, for example, the WAN 108 (shown in FIG. 1) or a LAN. In such an embodiment, the client device 104 retrieves the client software 216 from the file server over the network in order to execute the client software 216. In other embodiments, the client software 216 is delivered to the client device 104 for execution thereon in other ways. For example, in one such other embodiment, the client software 216 is implemented as a servelet (for example, in the JAVA(R) programming language) that is downloaded from a hypertext transfer protocol (HTTP) server and executed by the client device 104 using an Internet browser running on the client device 104.

The processing unit 212 also includes a network interface 222 that is used to couple the client device 104 to the WAN 108. In one implementation, the network interface 222 is an ETHERNET(R) network interface card that couples (via wired and/or wireless communication links) the client device 104 to the WAN 108 through appropriate intermediary networking equipment such as routers, hubs, modems and the like (not shown). In other embodiments, the network interface 222 includes a modem that couples the client device 104 to WAN 108 over, for example, one or more twisted-pair telephone lines.

The processing unit 210 further includes an input interface 224 that couples the input devices 202 to the processing unit 212. For example in one implementation, the input interface includes a personal system 2 (PS/2) or universal serial bus (USB) interface that couples the keyboard 204 and pointing device 206 to the programmable processor 214. The processing unit 210 also includes a display interface 226 that couples the display device 208 to the processing unit 212. In one such implementation, the display interface 226 comprises a graphics adapter card (for example, a SUPER VIDEO GRAPHICS ARRAY (SVGA) graphics adapter card) that couples the computer monitor 210 to the programmable processor 214.

In one implementation of the client device 104 shown in FIG. 2, the client device 104 is implemented as a “thin client” that is designed primarily to use and interact with software executing on the server 106 of FIG. 1. In another implementation, the client device 104 is implemented as a “thick client” using a personal computer or workstation that is capable of running various types of software locally in addition to using and interacting with software executing on the server 106.

The various components of the client device 104 are communicatively coupled to one another as needed using appropriate interfaces (for example, using buses, ports, and the like).

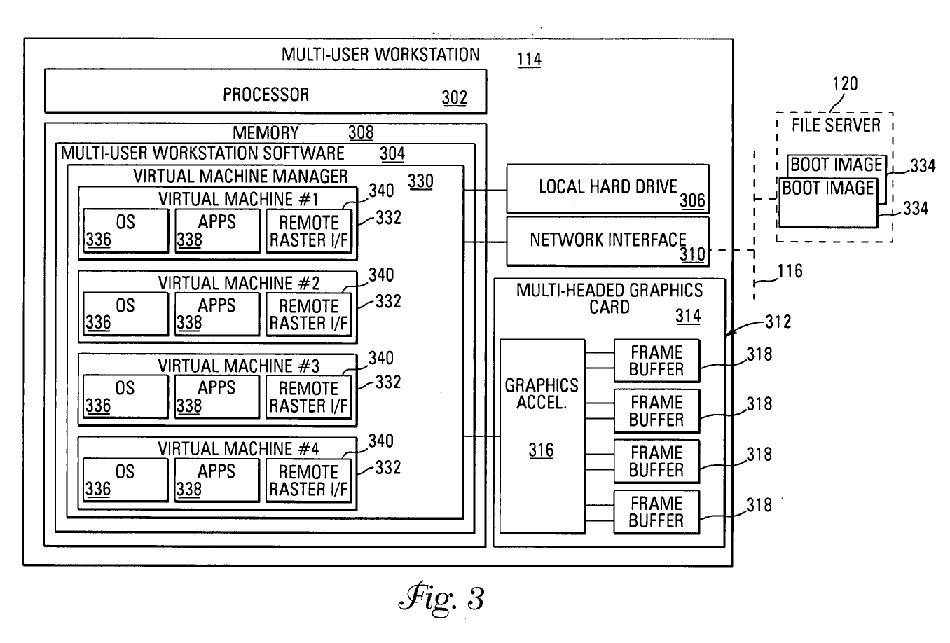

FIG. 3 is a block diagram of one embodiment of a multiple-user workstation computer 114 suitable for use in the embodiment of system 100 shown in FIG. 1. As shown in FIG. 1, a plurality of multiple-user workstations 114 is included in a pool 112. In one implementation of the embodiment of the server computer 114 shown in FIG. 3, each multiple-user workstation 114 is packaged in a blade configuration suitable for mounting in a rack. The embodiment of multiple-user workstation 114 shown in FIG. 3 includes a programmable processor 302. Multiple-user workstation software 304 (comprising appropriate program instructions) is executed by the programmable processor 302 to carry out at least some of the processing described here as being performed by each multiple-user workstation 114. The multiple-user workstation software 304 is stored on a computer-readable medium. In the embodiment shown in FIG. 3, the computer-readable medium comprises a local hard drive 306. During operation, the programmable processor 302 reads the program instructions that comprise the multiple-user workstation software 304 from the local hard drive 306 and executes the program instructions. The multiple-user workstation 114 further includes memory 308 for storing the program instructions and/or related data structures during execution of the multiple-user workstation software 304. In one implementation of such an embodiment, the memory 308 includes random access memory (RAM) and/or read-only memory (ROM).

In other embodiments, the multiple-user workstation software 304 is stored on other types of computer-readable media such as a flash disk, ROM, or removable media such as a floppy drive or a CD-ROM and/or on a computer-readable medium that is not local to the multiple-user workstation 114 (for example, on the file server 120).

The multiple-user workstation computer 114 also includes a network interface 310 that is used to couple the multiple-user workstation computer 114 to the LAN 116, which in turn is coupled to the WAN 108 (shown in FIG. 1). In one implementation, the network interface 310 is an ETHERNET(R) network interface card that couples (via wired and/or wireless communication links) the multiple-user workstation computer 114 to the LAN 116 and ultimately the WAN 108 through appropriate intermediary networking equipment such as routers, hubs, modems and the like. In other embodiments, the multiple-user workstation computer 114 is coupled to the LAN 116 and/or the WAN 108 using other types of network interfaces and/or using more than one network interface.

The multiple-user workstation computer 114 further comprises a display subsystem 312. In the embodiment shown in FIG. 3, the display subsystem 312 includes a multi-headed graphics card 314 that includes a graphics accelerator 316 and multiple frame buffers 318. In the particular implementation shown in FIG. 3, the multi-headed graphics card 314 includes four frame buffers 318, one for each of the up to four virtual machines (described below) that run on the multiple-user workstation 114. The graphics accelerator 316, under control of the multiple-user workstation software 304 executing on the programmable processor 302, is used to generate a session display image for each of the virtual machines executing on that multiple-user workstation 114. Each session display image generated by the graphics accelerator 316 comprises raster data (that is, data describing each pixel that makes up the display image). Each frame buffer 318 comprises memory that stores the raster data for the display image for a respective one of the virtual machines running on the multiple-user workstation 114. In one implementation, the memory used in each frame buffer 318 comprises dual-port random access memory that can be written to and read from at the same time.

In the embodiment shown in FIG. 3, the multiple-user workstation software 304 includes a virtual machine manager 330. The virtual machine manager 330 manages the execution of multiple virtual machines 332 on the multiple-user workstation 114. In the embodiment shown in FIG. 3, up to four virtual machines 332 are executed on each multiple-user workstation 114 (though other numbers of virtual machines 332 are used in other embodiments). The virtual machine manager 330 creates a logical computer for the software running within each virtual machine 332. When software executing within a virtual machine 332 requests access to a logical hardware element of the logical computer (for example, a network interface or a graphics device), the virtual machine manager 330 fulfills that request by accessing the corresponding physical hardware. The virtual machine manager 330 also mediates conflicting requests from different virtual machines 332 to access the same item of physical hardware.

As described below when the access manager 110 (shown in FIG. 1) requests that a particular multiple-user workstation 114 establish a session for a user 102, the virtual machine manager 330 instantiates a virtual machine 332. Then, the virtual machine 332 is instructed to retrieve and execute a boot image 334. In one implementation, the boot image 334 to be used is specified, for example, in a user profile for that user. The boot image 334 is stored on and retrieved from a computer-readable medium. In the embodiment shown in FIG. 3, the computer-readable medium comprises the file server 120 and the virtual machine manager 330 retrieves the specified boot image 334 from the file server 120 over the LAN 116. In other embodiments, boot images 334 are stored on other computer-readable media, for example, the local hard drive 306 of that multiple-user workstation 114.

Each boot image 334 comprises program instructions, that when executed by the virtual machine 332, boots a particular operating system 336 associated with that boot image 334 (for example, the UNIX, LINUX, or WINDOWS operating systems). During booting, other software is read from computer-readable media and is executed by the virtual machine 332 in accordance with the operation of that operating system 336 as configured in the boot image 334. After booting during normal operation, other software can be executed, for example, in response to a command input by the user 102 of that session. In the embodiment shown in FIG. 3, such other software executed by the virtual machine 332 during booting or during normal operation includes, for example, other portions of the operating system 336 and application software (APPS) 338.

The various components of the multiple-user workstation computer 114 are communicatively coupled to one another as needed using appropriate interfaces (for examples, using buses, ports, and the like).

As noted above, the user 102 that interacts with the session executing on the virtual machine 332 supplies input to the client device 104 (for example, using the keyboard 204 or pointing device 206 shown in FIG. 2). The remote computing software 217 executing on the client device 104 transmits the supplied input to the virtual machine 332 that hosts that session. Software executing on the multiple-user workstation 114 receives the supplied user input and forwards the user input to the appropriate virtual machine 332. In the embodiment shown in FIG. 3, remote access software 340 executed by each virtual machine 332 receives user input from a respective client device 104 and forwards the received user input as appropriate.

Also, the software executing on the virtual machine 332 generates a session display image (for example, containing a user interface and content) intended for a logical display device associated with the virtual machine 332. The session display image is generated by the software executing on the virtual machine 332 using the display subsystem 312. For example, application software 338 executing on the virtual machine 332 interacts with a device driver compatible with the display subsystem 312 to generate portions of the session display image associated with the application software 338. Likewise, the operating system 336 interacts with the device driver to generate the portions of the session display image associated with the operating system 336. The session display image, in the embodiment shown in FIG. 3, is generated and stored in the respective frame buffer 318 associated with that virtual machine 332.

For each session hosted by a multiple-user workstation 114, software executing on the multiple-user workstation 114 retrieves at least a portion of the raster data for that session's session display image and transmits the retrieved raster data to the client device 104 associated with that session. In the embodiment shown in FIG. 3, the remote access software 340 executed by each virtual machine 332 determines when the corresponding client display image for that virtual machine 330 should be refreshed. When the remote access software 340 determines that such a client display image should be refreshed, the remote access software 340 retrieves at least a portion of the session display image stored in the frame buffer 318 associated with that virtual machine 332. The session display image stored in the frame buffer 318 is stored as raster data. In one implementation of such an embodiment, the remote access software 340 compresses the retrieved raster data (for example, using image compression techniques promulgated by the Joint Photographic Experts Group (JPEG)) and transmits the compressed raster data to the client device 104 associated with that session.

The remote computing software 217 executing on the respective client device 104 decompresses the received compressed raster data and renders on the display device 208 (shown in FIG. 2) at least a portion of the session display image (that is, refreshes the client display image) using the uncompressed raster data. The user 102 interacts with the client display image by providing additional input to the client device 104. For example, by “clicking on” a portion of the client display image (for example, a user-interface element such as menu or button) using the pointing device 206 coupled to the client device 104.

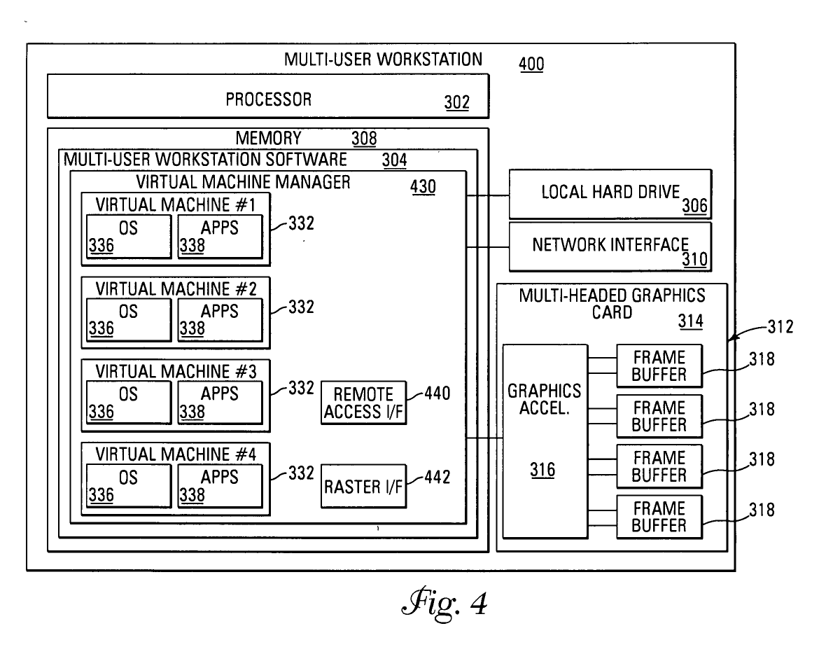

As noted above, the remote access software 340 executed by each virtual machine 332 receives and forwards user input and retrieves, compresses, and transmits raster data for that virtual machine's session display image. In other embodiments, such functionality is implemented in other ways. FIG. 4 is a block diagram of another embodiment of a multiple-user workstation computer 400 suitable for use in the system 100 shown in FIG. 1. The embodiment of multiple-user workstation computer 400 shown in FIG. 4 includes the same components and software as described above in connection with the embodiment of multiple-user workstation computer 114 shown in FIG. 3 and such components and software are referenced in FIG. 4 using the same reference numerals used in FIG. 3.

In the embodiment of multiple-user workstation computer 400 shown in FIG. 4, a virtual machine manager 430, in addition to carrying out the processing described above in connection with virtual machine manager 330 of FIG. 3, includes a remote access interface 440 that, for all of the virtual machines 332 executing on the multiple-user workstation 400, receives user input from a respective client device 104 and forwards the received user input to the corresponding virtual machine 332.

In the embodiment of multiple-user workstation computer 400 shown in FIG. 4, the virtual machine manager 430 further includes a raster data interface 442. When the remote access interface 440 determines that a client display image for a virtual machine 332 executing on the multiple-user workstation computer 400 should be refreshed, the remote access interface 440 requests that the raster data interface 442 retrieve at least a portion of the corresponding session display image stored in the frame buffer 318. In one implementation of such an embodiment, the raster data interface 442 compresses the retrieved raster data (for example, using JPEG compression) and returns the compressed raster data to the remote access interface 440. The remote access interface 440 then transmits the compressed raster data to the respective client device 104. The client device 104 receives the compressed raster data from the multiple-user workstation 400 and the client software 216 executing on the client device 104 decompresses the received compressed raster data and refreshes the client display image displayed on that client device 104 using the uncompressed raster data.

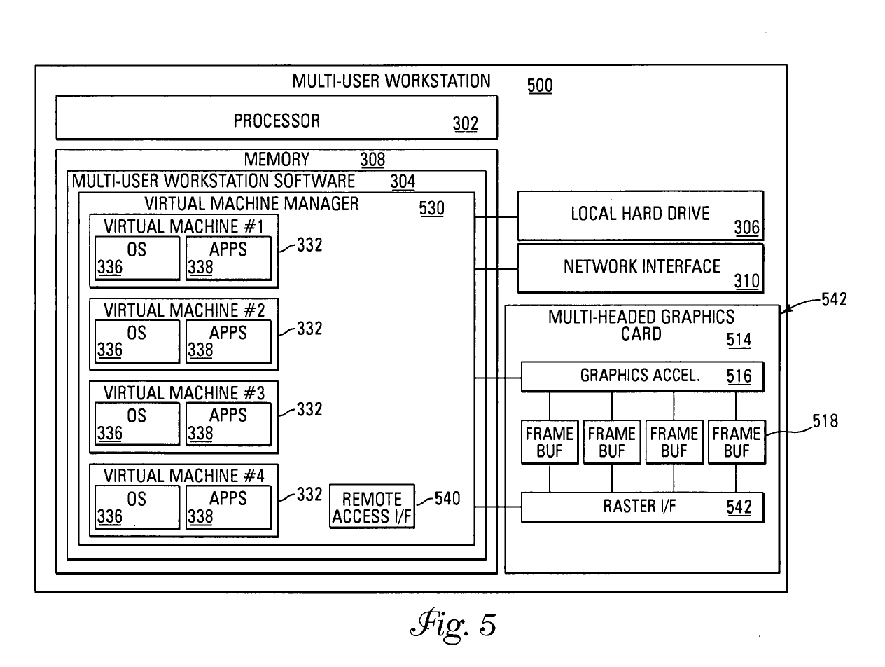

FIG. 5 is a block diagram of another embodiment of a multiple-user workstation computer 500 suitable for use in the system 100 shown in FIG. 1. The embodiment of multiple-user workstation computer 500 shown in FIG. 5 includes the same components and software as described above in connection with the embodiment of multiple-user workstation computer 114 shown in FIG. 3 and such components and software are referenced in FIG. 5 using the same reference numerals used in FIG. 3.

In the embodiment of multiple-user workstation computer 500 shown in FIG. 5, as with multiple-user workstation computer 400, a virtual machine manager 530, in addition to carrying out the functionality described above in connection with virtual machine manager 330 of FIG. 3, includes a remote access interface 540 that, for all of the virtual machines 332 executing on the multiple-user workstation 500, receives user input from a respective client device 104 and forwards the received user input to the corresponding virtual machine 332.

The embodiment of multiple-user workstation computer 500 shown in FIG. 5 also includes a display subsystem 512 that includes a multi-headed graphics card 514 comprising a graphics accelerator 516 and multiple frame buffers 518 as described above in connection with FIG. 3. The multi-headed graphics card 514 further includes a raster data interface 542 (implemented, for example, in software, firmware, and/or hardware).

When the remote access interface 540 determines that a client display image for a virtual machine 330 executing on the server computer 500 should be refreshed, the remote access interface 540 requests that the raster data interface 542 retrieve at least a portion of the corresponding session display image stored in the frame buffer 518. In one implementation of such an embodiment, the raster data interface 542 compresses the retrieved raster data (for example, using JPEG compression) and returns the compressed raster data to the remote access interface 540. The remote access interface 540 then transmits the compressed raster data to the respective client device 104. The client device 104 receives the compressed raster data from the server computer 500 and the client software 216 executing on the client device 104 decompresses the received compressed raster data and refreshes the client display image displayed on that client device 104 using the uncompressed raster data.

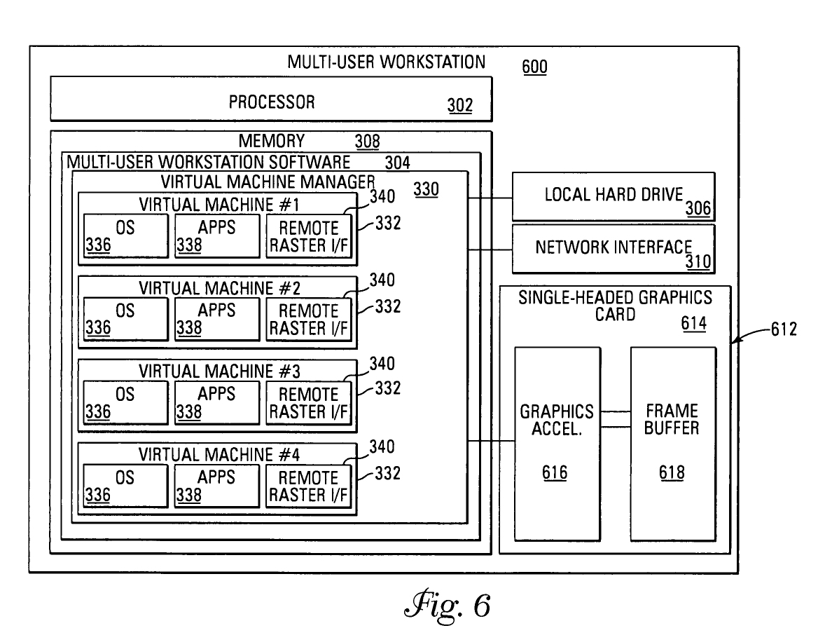

FIG. 6 is a block diagram of another embodiment of a multiple-user workstation computer 600 suitable for use in the system 100 in FIG. 1. The embodiment of multiple-user workstation computer 600 shown in FIG. 6 includes the same components and software as described above in connection with the embodiment of multiple-user workstation computer 114 shown in FIG. 3 and such components and software are referenced in FIG. 6 using the same reference numerals used in FIG. 3.

In the embodiment of multiple-user workstation computer 600 shown in FIG. 6, the multiple-user workstation computer 600 includes a display subsystem 612 that comprises a single-headed graphics card 614. The single-headed graphics card 614 includes a graphics accelerator 616 and a single frame buffer 618.

The graphics accelerator 616, under control of the multiple-user workstation software 304 executing on the programmable processor 302, is used to generate a session display image for each of the virtual machines executing on that multiple-user workstation 600. Each session display image generated by the graphics accelerator 616 comprises raster data that is stored in the single frame buffer 618. Each session display image is stored in a different portion of the single frame buffer 618. In this way, a single-headed graphics card 614 can be used to implement a virtual multi-headed graphics card having multiple virtual frame buffers. The multiple virtual frame buffers correspond to the different portions of the single frame buffer 618 in which each of the different session display images are stored.

The frame buffer 618 comprises memory for storing the raster data of each session display image. In one implementation, the memory used in the single frame buffer 618 comprises dual-port random access memory that can be written to and read from at the same time.

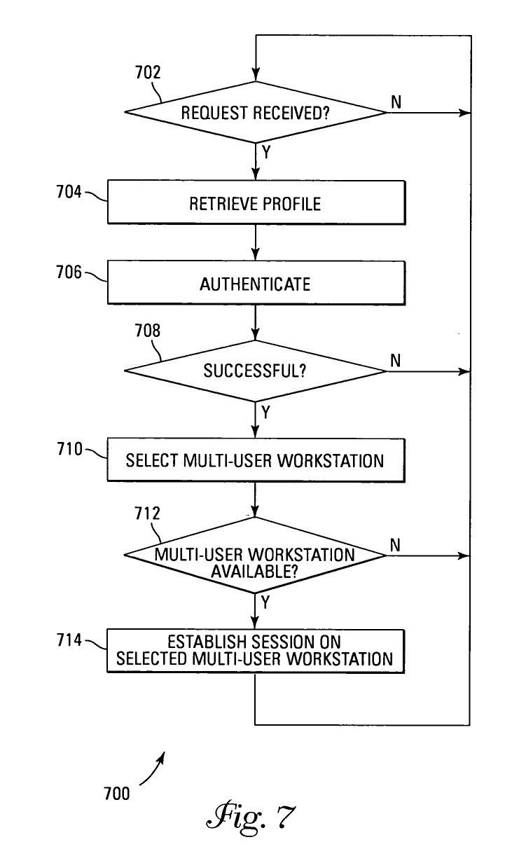

FIG. 7 is a flow diagram of one embodiment of a method 700 of selecting a multiple-user workstation computer on which to establish a remote computing session. The embodiment of method 700 shown in FIG. 7 is described here as being implemented using the system 100, client device 104, and the multiple-user workstation computer 114 shown in FIGS. 1-3, though other embodiments are implemented in other ways and/or using other systems, client devices, and/or multiple-user workstation computers. In one implementation, the embodiment of method 700 shown in FIG. 7 is implemented in software by the access manager 110 (shown in FIG. 1).

Method 700 comprises waiting for a request from a client device 104 to establish a session (block 702 of FIG. 7). During a session, a user 102 of a client device 104 interacts with software that is executing on at least one of the multiple-user workstation computers 114 of the system 106. In one embodiment, the remote computing software 217 executing on the client device 104 receives an input from a user 102 indicating that the user 102 wishes to establish such a session. In response to such input, the remote computing software 217 sends a request to establish a session to the access manager I 10 over the WAN 108. In one implementation, the request identifies the user 102 (for example, by including a user identifier for that user 102) and the client device 104 that is sending the request (for example, by including an identifier for that client device 104 such as an Internet Protocol (IP) address associated with the client device 104) and includes authentication information for that user 102 (for example, a password or key for that user 102).

When such a request is received, the access manager 10 retrieves a profile associated with the request (block 704). For example in one implementation of such an embodiment, the access manager 110 retrieves a profile from the directory server 118 over the LAN 116. The particular profile is selected based on, for example, the user 102 and/or the client device 104 that is identified in the received request. In such an implementation, the profile includes authentication information (for example, a password or key) used to authenticate the identified user and the type of software that the identified user is allowed to run (for example, by specifying a boot image 334 for that user).

The access manager 10 authenticates the user 102 identified in the request (block 706). For example in one implementation, the access manager 10 compares the authentication information included in the request with the authentication information included in the retrieved profile using, for example, a password comparison or a public key authentication technique. If the user 102 identified in the request is not successfully authenticated (checked in block 708), the session is not established and method 700 returns to block 702 to wait for the next request.

If the user 102 identified in the request is successfully authenticated, the access manager 10 selects a multiple-user workstation computer 114 on which to establish the session (block 710). In one embodiment, the access manager 110 maintains a data structure that stores the current status of each multiple-user workstation 114 in the pool 112 (for example, whether each multiple-user workstation 114 is functional and how many sessions are currently running on each multiple-user workstation 114). In such an embodiment, the access manager 110 selects a multiple-user workstation 114 in a way that balances the load across all the functional multiple-user workstation 114 in the pool 112 having available capacity (for example, using a round-robin scheme). If there is a multiple-user workstation 114 having available capacity to establish the session (checked in block 712), the access manager 110 sends a message to the selected multiple-user workstation 114 instructing the selected multiple-user workstation 114 to establish the session (block 714). In one embodiment, the access manager 110 sends such a message to the selected multiple-user workstation 114 over the LAN 116. If there is no multiple-user workstation 114 having available capacity to establish the session, the session is not established and method 700 returns to block 702 to wait for the next request.

Although in the embodiment shown in FIG. 7 each session is established on a single multiple-user workstation 114, in other embodiments a session can be established on multiple multiple-user workstations 114 (for example, if indicated in the user's profile or in response to a request by the user 102 to establish a particular type of session requiring computing resources from multiple multiple-user workstations 114).

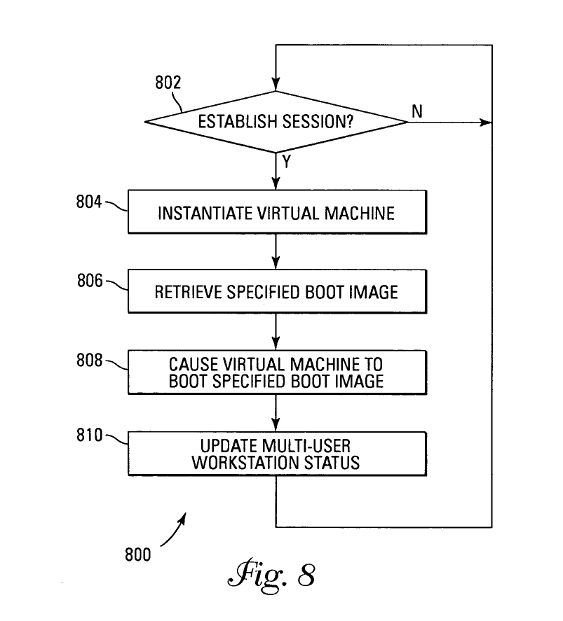

FIG. 8 is a flow diagram of one embodiment of a method 800 of establishing a remote computing session on a multiple-user workstation. The embodiment of method 800 shown in FIG. 8 is described here as being implemented using the system 100, client device 104, and the multiple-user workstation computer 114 shown in FIGS. 1-3, though other embodiments are implemented in other ways and/or using other systems, client devices, and/or multiple-user workstation computers. In one implementation, the embodiment of method 800 shown in FIG. 8 is implemented in software by the virtual machine manager 330 executing on a particular server computer 114 (shown in FIG. 3).

Method 800 comprises waiting for a message sent by the access manager 110 to that multiple-user workstation 114 to establish a session on that multiple-user workstation 114 (block 802 of FIG. 8). In the embodiment shown in FIG. 8, the virtual machine manager 330 waits for and receives such messages from the access manager 110. When the virtual machine manager 330 receives a message to establish a session on the multiple-user workstation 114 on which the virtual machine manager 330 executes (also referred to here as the “selected multiple-user workstation” 114), the virtual machine manager 330 instantiates a virtual machine 332 for the session (block 804) and retrieves an appropriate boot image to be executed by that virtual machine 332 (block 806). In one implementation, the message sent by the access manager 110 to the selected multiple-user workstation 114 specifies a boot image 334 to be executed by the virtual machine 332. In such an implementation, the particular boot image 334 to use for a particular user 102 is stored in a profile stored on the directory server 118 for that user 102. In such an implementation, the specified boot image 334 is retrieved from the file server 120 over the LAN 116 (as shown in FIG. 3).

After retrieving the specified boot image 334, the virtual machine manager 330 instructs the instantiated virtual machine 332 to execute the retrieved boot image 334 in order to establish the session on the selected multiple-user workstation 114 (block 808). As noted above, each boot image 334 comprises program instructions, that when executed by the instantiated virtual machine 332, boots a particular operating system 336 associated with that boot image 334. During booting, other software is read from computer-readable media (for example, file server 120 and/or the hard drive 306 local to the selected multiple-user workstation 114) and executed by the instantiated virtual machine 332 in accordance with the operation of that operating system 336 as configured in the boot image 334. After booting during normal operation, other software can be executed, for example, in response to a command input by the user 102 of that session.

The virtual machine manager 330 sends an update message to the access manager 110 that updates the current status of the selected multiple-user workstation 114 (block 810). In one embodiment, the update message includes the number of virtual machines 332 executing on the selected multiple-user workstation 114 (that is, the number of sessions established on the selected multiple-user workstation 114).

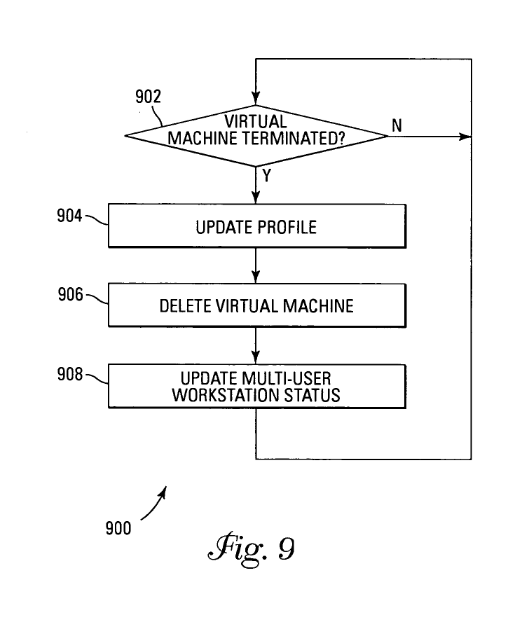

FIG. 9 is a flow diagram of one embodiment of a method 900 of terminating a remote computing session on a multiple-user workstation. The embodiment of method 900 shown in FIG. 9 is described here as being implemented using the system 100, client device 104, and the multiple-user workstation 114 shown in FIGS. 1-3, though other embodiments are implemented in other ways and/or using other systems, client devices, and/or multiple-user workstation. In one implementation, the embodiment of method 900 shown in FIG. 9 is implemented in software by the virtual machine manager 330 executing on a particular multiple-user workstation 114 (shown in FIG. 3).

The virtual machine manager 330 determines when a virtual machine 332 running on the multiple-user workstation 114 has been terminated (block 902). A virtual machine 332 terminates, for example, because a user 102 has indicated that the user 102 wishes to terminate the session associated with that virtual machine. In one embodiment, a virtual machine 332 also terminates upon the occurrence of some other condition (also referred to here as a “termination condition”). Examples of termination conditions include if the user 102 has not supplied any input to that virtual machine 332 for a predetermined “timeout” period, if the user 102 has committed some improper act, or if the user 102 has exceeded a pre-specified computer resource limit.

When the virtual machine manager 330 determines that a virtual machine 332 has been terminated, the virtual machine manager 330 updates the user profile (block 904). For example in one implementation of the embodiment shown in FIG. 9, the user profile includes information such as the last time the user 102 established a session or the amount of various computer resources the user 102 has used. Such information is updated when a virtual machine 332 (and the associated session) terminates. In the embodiment shown in FIG. 9, the user profile is updated by sending a message to the directory server 118 on which the user profile is stored.

Also, when a virtual machine terminates, the virtual machine manager 330 deletes the virtual machine 332 (block 906). Deleting the virtual machine 332 frees up the resources (for example, memory and processor time) previously allocated to the deleted virtual machine 332. In addition, the virtual machine manager 330 sends an update message to the access manager 110 that updates the current status of the selected multiple-user workstation 114 (block 908).

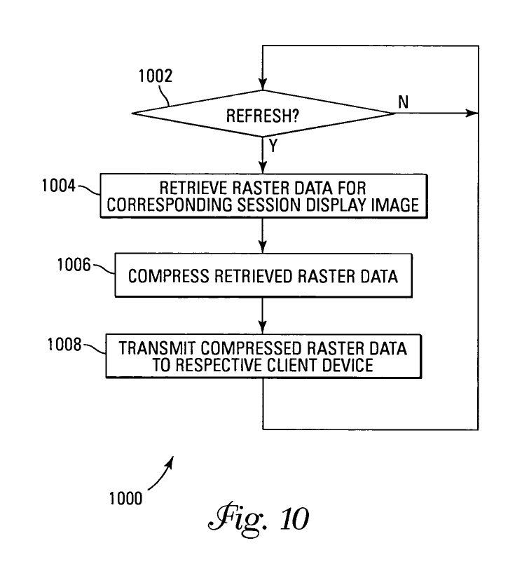

FIG. 10 is a flow diagram of one embodiment of a method 1000 of compressing and transmitting raster data from a session display image. The embodiment of method 1000 shown in FIG. 10 is described here as being implemented using the system 100 and the multiple-user workstation computer 114 shown in FIGS. 1 and 3, though other embodiments are implemented in other ways and/or using other systems and/or multiple-user workstation computers. In one implementation, the embodiment of method 1000 shown in FIG. 10 is implemented in software by remote access and raster data interface software 340 executing within a particular virtual machine 332 (shown in FIG. 3). In other implementations and embodiments, an embodiment of method 1000 is implemented in other ways (for example, using the multiple-user workstation computers 400 and 500 shown in FIGS. 4 and 5, respectively).

As noted above, the software executing on a particular virtual machine 332 generates a session display image (for example, containing a user interface and content) intended for display on a logical display device associated with that virtual machine 332. The session display image is generated by the software executing on the virtual machine 332 using the display subsystem 312 of the multiple-user workstation 114. For example, application software 338 (shown in FIG. 3) executing on the virtual machine 332 interacts with a device driver in order to generate those portions of the session display image associated with the application software 338. Likewise, the operating system 336 interacts with such a device driver to generate those portions of the session display image associated with the operating system 336. The session display image, in the embodiment shown in FIG. 3, is generated and stored in the frame buffer 318 associated with that virtual machine 332.

Method 1000 comprises determining when a client display image displayed on a client device 104 associated with a particular virtual machine 332 should be refreshed (checked in block 1002). For example in one implementation, such a client display image is refreshed at periodic intervals and/or when a given amount of the corresponding session display image has changed. When it is time to refresh such a client display image, at least a portion of the raster data for the corresponding session display image is retrieved (block 1004). In the embodiment shown in FIG. 10 that is implemented using the multiple-user workstation computer 114 shown in FIG. 3, at least a portion of the raster data for the corresponding session display image is retrieved from the frame buffer 318 in which such raster data is stored. In one embodiment, the raster data for the entire session display image is retrieved each time a refresh is performed. In another embodiment, only the raster data for portions of the session display image that have changed since the last refresh are retrieved.

The retrieved raster data is compressed (block 1006). In one embodiment, the retrieved raster data is compressed in accordance with the JPEG standard. In other embodiments, other compression techniques are used. The compressed raster data is transmitted to the client device 104 (block 1008). In one embodiment, the compressed raster data is transmitted to the client device 104 over the WAN 108 in accordance with the transport control protocol and internet protocol (TCP/IP) standards.

FIG. 11 is a flow diagram of one embodiment of a method 1100 of refreshing raster data displayed on a client device for a remote computing session. The embodiment of method 1100 shown in FIG. 11 is described here as being implemented using the system 100 and the client computer shown in FIGS. 1 and 2, though other embodiments are implemented in other ways and/or using other systems and/or client devices. In one implementation, the embodiment of method 1100 shown in FIG. 11 is implemented in software by the remote computing software 217 (shown in FIG. 2).

When the remote computing software 217 receives compressed raster data from the multiple-user workstation computer 114 that hosts a session (checked in block 1102), the remote computing software 217 decompresses the received compressed raster data (block 1104) and updates the client display image using the decompressed raster data (block 1106). In an embodiment where the remote computing software 217 receives raster data for the entire session display image, the remote computing software 217 updates the entire client display image with the decompressed raster data. In an embodiment where the remote computing software 217 receives raster data for a portion of the session display image, the remote computing software 217 updates, with the decompressed raster data, any portions of the client display image that correspond to portions of the session display image that have changed since the last refresh. In an embodiment where the raster data is compressed using JPEG compression, the remote computing software 217 decompresses and updates the client display image using standard JPEG processing.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory previously or now known or later developed, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and DVD disks. Any of the foregoing may be supplemented by, or incorporated in, specially-designed application-specific integrated circuits (ASICs).

What is claimed is:

1. A method comprising:
establishing a plurality of remote computing sessions on a computer, wherein each of the plurality of remote computing sessions has an associated client device; and
for each of the plurality of remote computing sessions:
instantiating, on the computer, a virtual machine for the respective remote computing session;
executing software on the virtual machine for the respective remote computing session, wherein there is a display image for the respective remote computing session that comprises raster data; and
transmitting, to the client device associated with the respective remote computing session, at least a portion of the raster data of the display image for the respective remote computing session, wherein the client device associated with the respective remote computing session displays the at least a portion of the raster data.

2. The method of claim 1, further comprising, for each of the plurality of remote computing sessions, generating the respective display image for the respective remote computing session.

3. The method of claim 1, further comprising, for each of the plurality of remote computing sessions, compressing the raster data that is transmitted to the client device associated with the respective remote computing session.

4. The method of claim 1, further comprising, for each of the plurality of remote computing sessions, receiving user input from the client device associated with the respective remote computing session.

5. The method of claim 1, wherein each of the plurality of remote computing sessions is established on one of a plurality of computers, wherein the virtual machine for the respective remote computing session is instantiated on the computer on which the respective remote computing is established, and wherein a plurality virtual machines are instantiated on each of the plurality of computers.

6. A computer program product comprising program instructions, embodied on a computer-readable medium, that are operable to cause a programmable processor to:
establish a plurality of remote computing sessions on a computer, wherein each of the plurality of remote computing sessions has an associated client device;
for each of the plurality of remote computing sessions:
instantiate, on the computer, a virtual machine for the respective remote computing session;
execute software on the virtual machine for the respective remote computing session, wherein there is a display image for the respective remote computing session that comprises raster data; and
transmit, to the client device associated with the respective remote computing session, at least a portion of the raster data of the display image for the respective remote computing session, wherein the client device associated with the respective remote computing session displays the at least a portion of the raster data.

7. The computer program product of claim 6, wherein the program instructions are further operable to cause the programmable processor to generate the display image for the respective remote computing session.

8. An apparatus comprising:
means for establishing a plurality of remote computing sessions on a computer, wherein each of the plurality of remote computing sessions has an associated client device;
means for instantiating, on the computer, a virtual machine for each of the plurality of remote computing sessions;
means for executing software on the virtual machine for each of the plurality of remote computing sessions, wherein there is a display image for each of the plurality of remote computing sessions that comprises raster data; and
means for transmitting, to the client device associated with each of the plurality of remote computing sessions, at least a portion of the raster data of the display image for the respective remote computing session, wherein the client device associated with the respective remote computing session displays the at least a portion of the raster data.

9. The apparatus of claim 8, further comprising means for generating the display image for each of the plurality of remote computing sessions.

10. A method comprising:
receiving from each of a plurality of client devices a request to establish a session;
for each request that is received:
selecting at least one of a plurality of computers on which to establish the session for the respective request;
instantiating a virtual machine on the computer selected for the respective request;
establishing the session for the respective request on the virtual machine, wherein there is a session display image for the session established for the respective request; and
transmitting, to the client device from which that request was received, at least a portion of the raster data of the session display image for the session established for the respective request.

11. The method of claim 10, further comprising, for each request that is received, generating the session display image for the session established for the respective request.

12. The method of claim 11, wherein, for each request that is received, establishing the session for the respective request on the virtual machine comprises executing a boot image on the virtual machine.

13. The method of claim 11, wherein, for each request that is received, establishing the session for the respective request on the virtual machine comprises executing on the virtual machine at least one of an operating system, application software, and remote access software.

14. The method of claim 11, further comprising, for each request that is received, authenticating a user associated with the respective request.

15. The method of claim 11, further comprising, for each request that is received, retrieving a profile for the respective request.

16. A system comprising:
a plurality of server computers in communication with a plurality of client devices;
an access manager in communication with the plurality of server computers and the plurality of client devices;
wherein the access manager receives from each of the plurality of client devices a request to establish a session for the respective client device;
wherein for each request that is received by the access manager:
the access manager selects at least one of the plurality of server computers on which to establish the session for the respective request;
a virtual machine is instantiated on the server computer selected for the respective request;
the session for the respective request is established on the respective virtual machine;
there is a session display image for the session established for the respective request, wherein the session display image comprises raster data; and
at least a portion of the raster data of the session display image for the session established for the respective request is transmitted to the client device from which the respective request was received.

17. The system of claim 16, wherein, for each request that is received by the access manager, a session display image for the session established for the respective request is generated.

18. The system of claim 16, wherein the access manager, for each request that is received, instructs the server computer selected for the respective request to establish the session for the respective request thereon.

19. The system of claim 16, further comprising a network that communicatively couples the plurality of server computers, the plurality of client devices, and the access manager to one another.

20. The system of claim 19, wherein the network comprises a wide area network.

21. The system of claim 16, further comprising a local area network that communicatively couples the plurality of server computers and the access manager to one another.

22. A multi-user workstation, comprising:
a programmable processor;
memory coupled to the programmable processor;
software that is executable on the programmable processor and that uses the memory when executed, wherein the software is operable to establish a plurality of remote computing sessions on the multi-user workstation, wherein each of the plurality of remote computing sessions has an associated client device;
wherein, for each of the plurality of remote computing sessions, the software is operable to:
instantiate, on the multi-user workstation, a virtual machine for the respective remote computing session;
execute software on the virtual machine for the respective remote computing session, wherein there is a display image for the respective remote computing session; and
transmit, to the client device associated with the respective remote computing session, at least a portion of the raster data of the display image for the respective remote computing session, wherein the client device associated with the respective remote computing session displays the at least a portion of the raster data.

23. The multi-user workstation of claim 22, generate the display image for the respective remote computing session.

24. The multi-user workstation of claim 22, wherein the software comprises a virtual machine manager.

25. The multi-user workstation of claim 22, wherein, for each of the plurality of remote computing sessions, the software is further operable to compress the raster data transmitted to the client device associated with the respective remote computing session.

26. The multi-user workstation of claim 22, wherein the software is operable to generate the display image for each of the plurality of remote computing sessions using a display subsystem communicatively coupled to the programmable processor.

27. The multi-user workstation of claim 26, wherein the display subsystem comprises a frame buffer, wherein the raster data for each of the plurality of remote computing sessions is stored in the frame buffer.

28. The multi-user workstation of claim 26, wherein the display subsystem comprises a plurality of frame buffers.

29. The multi-user workstation of claim 26, wherein the display subsystem comprises a graphics accelerator.
